(19) United States
(12) Patent Application Publication
(10) Pub. No.: US 2007/0044825 A1
(43) Pub. Date: Mar. 1, 2007

(54) Wheel well deicer

(76) Inventor: Joanie Dalessandro, Westampton, NJ (US)

Correspondence Address: Joanie Dalessandro, 9 Berkshire Road, Westampton, NJ, 08060, US

(21) Appl. No.: 11/410,940

(22) Filed: Aug. 23, 2005

(51) Int. Cl. B08B 3/00

(52) U.S. Cl. 134/123

(57) ABSTRACT

The nozzles of a wheel well deicer are connected to the electrically controlled pump motor. The nozzles are located at the top of all four-wheel wells. These nozzles are securely mounted and connected to a rubber line which is connect to the electronic pump to carry thereon electrically conductive plate which is Connectable with a pair of stationary contacts. When an electrical connection is Established between the pair of stationary contacts, a washer pump supplied with electric current is driven to eject a washer liquid through nozzles onto the surface of the wheel well. The conductive plates are so located that the electrical connection between the pair of stationary contacts is established only during time periods in which the power switch located inside the vehicle is put on position which then ejects the liquid deicer through the line into the nozzles that are located in all four wheel wells. Then liquid deicer from the reservoir will be ejected from the nozzles.

### BACKGROUND OF THE INVENTION

The present invention relates to preventing ice and snow build up in motor vehicle wheel wells, and more particularly to a device for controlling the duration of ejecting a deicer liquid onto the surface of the wheel wells in Motor vehicles. Such as automotive vehicles are in general get ice and snow build up in wheel wells to obtain safer road travel during a snow storm. Additionally, vehicles are further equipped with a wheel well deicer will and can prevent tires from not turning and causing a possible accident. A conventional wheel well deicer is so constructed that a deicer liquid Are continuously ejected onto the surface of the wheel wells as long as the driver continues to push a switch to operate the washer.

### SUMMARY OF THE INVENTION

In view of the above, the present invention contemplates to solve the problems encountered in steering problems and dangerous stopping of motor vehicle tires. It is an object of the present invention to provide a safer driving system during snowstorms.

### BRIEF DESCRIPTION OF THE DRAWINGS

FIG. 1 is an illustration partly in section of an embodiment of an essential part of a system in accordance with the invention is an elevation view of the essential part of the system of FIG. 1.

FIG. 1 view taken showing a contact mechanism of the system of FIG. 1.

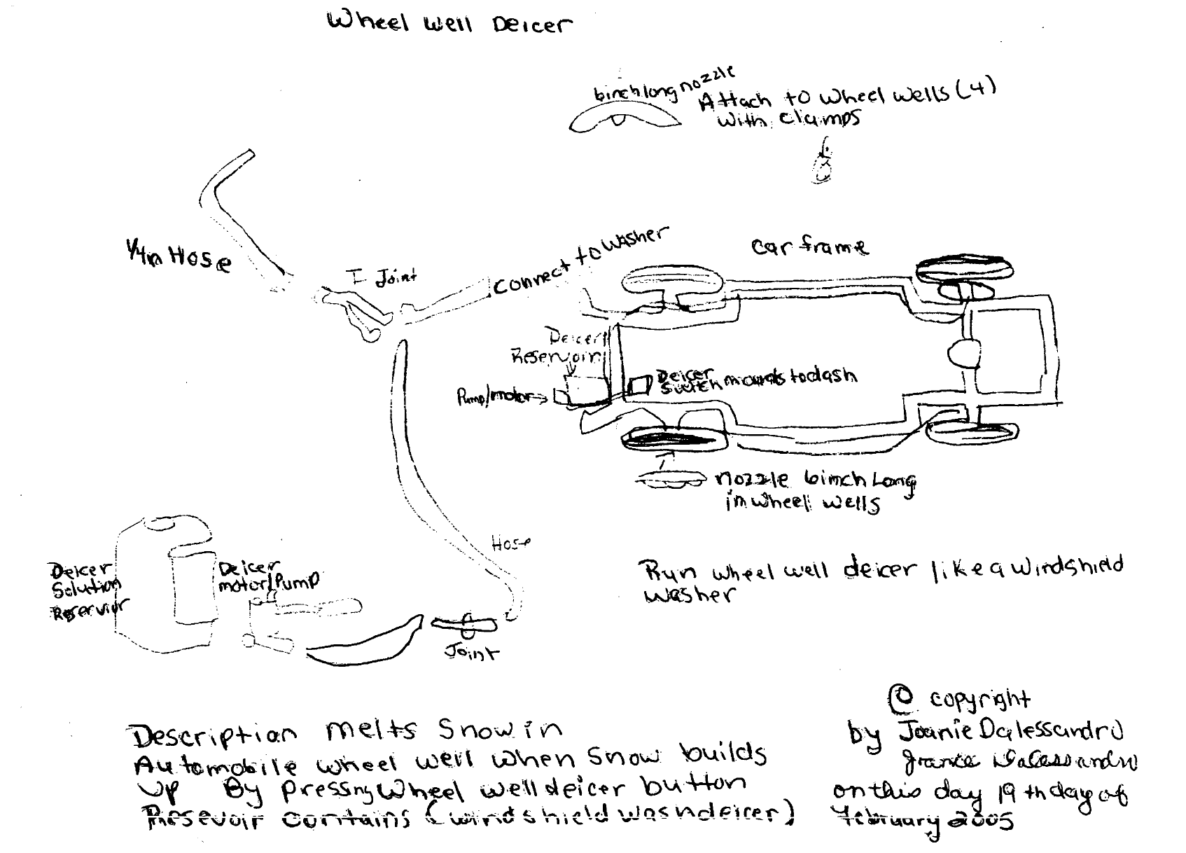

Illustrating one stage in the operation of the system; but showing another stage in the operation of the system of FIG. 1; is an illustration partly in section of an essential part of another embodiment of the system in accordance with the present invention. FIG. 1 is a cross-sectional view but showing the contact mechanism of the system, illustrating the stage in the operation of the system.

### DESCRIPTION OF THE PREFERRED EMBODIMENTS

Referring now to FIG. 1 drawing,

There it is shown an embodiment of a system in accordance with the present invention, which system includes deicer for the wheel wells of a motor vehicle such as an automotive vehicle.

The reference numeral 3 indicates an electrical connector to be used for an electrical connection in an electric circuit. Connectable by the conductive T-joint 12, of an actuate shape as clearly shown in FIG. 1, and securely supported by a rubber member 8 on the outer surface of the motor 1. In the path of the sprays of deicer liquid 8, which are ejected from nozzles 4, 5, 6, and 7 on the surface of the wheel wells.

The nozzles 24 and 25 are connected through a common pipe 13 to the discharge port of a deicer pump 1 whose inlet port opens into the inside of a deicer liquid reservoir 10.

The pump 1 is of the electrically operated type and, one terminal of the pump 1 is grounded through a switch 3. The contact is electrically connected to the positive terminal of a battery 16 whose negative terminal is grounded. The field coil 17 is electrically connected to the battery 16. The field coil 17 is electrically connected to a contact point of a deicer switch 3, which is operated by a driver of the vehicle. The stationary contact 17 is electrically connected to the positive terminal of the battery 16. A contact point of the deicer switch is grounded as well as the conductive plate.

The operation of the thus arranged system is as follows: At first, the operation of the wheel well will be explained. When the wheel well deicer switch is put into a position for operating the electric connection is established between the contact points and the electric current from the battery 16 flows through the field coil 17.

As a result, accordingly the electric current from the battery 16 flows through the field coil 17, then pumps the deicer liquid into the 4 wheel well nozzles, 4, 5, 6, and 7.

When the deicer switch is put into the “OFF” position, an electric connection is established between the contact points. So that the contact 17 is electrically connected to the positive terminal of the battery 16 through the contact point, the field coil 17, and the pump 1. At this moment, the voltages of the contacts 3, 17 and 16 are at the same level since the contact pump motor 1 is electrically connected to the positive terminal of the battery 16.

Accordingly, the pump motor 1 stops the instant the contacts 3 and 17.

Accordingly, due to the fact that the pump motor 1 is grounded, if the deicer switch 3, is put into the “OFF” position as mentioned above, electric current from the battery 16 flows through the field coil 17.

During the “go” 3, when the driver of the vehicle operates to close the deicer switch 3, the wheel well deicer is constructed and arranged to eject the deicer liquid from the nozzles 4, 5, 6, and 7 onto the surface of the wheel wells. As will be discussed in detail hereinafter.

The electric current from the battery 16 flows through the contact 17, contact the motor pump 1 and the switch 3 so as to operate the motor pump 1 to eject the deicer liquid through the nozzles 14 onto the surface of the wheel well 4, 5, 6, and 7.

The contacts 17 and 16 contact the surface of the base member 8 which surface is made of an electric insulating material and accordingly the electric connection between the contacts 17 and 16 is blocked.

Then, the current flow to the motor pump 1 is blocked so that the deicer liquid is not ejected from the nozzles 14 each of four deicer nozzles 4, 5, 6, and 7, and 10 is provided with the suction port open to the washer liquid tank 31. The discharge ports of the motor pump 1 is fluidly connected through pipes 12, 13, 11 and 8 to the nozzles 4, 5, 6, and 7, respectively.

One terminal on the motor pump 1 is electrically connected to the common deicer switch 3.

The contact 17 is electrically connected to the positive terminal of the battery 16.

When the deicer switch 3 is closed, the electrical connections are established between the contacts 17 and 16 and the contacts 1 accordingly the deicer liquids 10, is ejected from the nozzles 4, 5, 6, and 7, respectively.

What is claimed is:

1. A system for use in a motor vehicle having wheel wells, comprising: first nozzles being mounted in all four vehicle wheel wells. motor pump having the four nozzles which is fluidly connected to an electrically operated first washer pump for ejecting washer liquid through the first nozzle when supplied with electric current. Then a first stationary contact electrically connected to said first washer pump; first Stationary contacts being connectable with said first stationary contact to supply electric current to said first washer pump through said first stationary contact; said four nozzles contact being formed to be connectable with Said stationary contact within a first range in which said nozzle ejects in the direction from the nozzles in the line from which the washer pumps liquid being ejected into the four wheel wells when the washer pumps the liquid being ejected from said nozzle; melting the built up snow and ice in the wheel wells; all four nozzles which is fluidly connected to an electrically operated second washer pump for ejecting washer liquid through all four nozzles when supplied with electric current;

2. A system as claimed in claim 1, in which said first stationary contact includes four stationary contacts, which are separate from each other, the electrical connection being established between said four stationary contacts upon contact with each of said all four contacts, said two stationary contacts being electrically connected to said washer pump and an electric source, respectively.

3. A system as claimed in claim 1, further comprising a washer switch which is closeable to supply the deicer pump with the electric current.

4. A system as claimed in claim 3, in which said first contact base member is mounted in all four wheel wells of the vehicle mechanically connected to said first deicer pump motor.

5. A system as claimed in claim 3, in which the four nozzles are actuate conductive located on the same circumference concentrically with said wheel well. A system as claimed in claim 4, in which said four stationary contacts, which includes stationary contacts, which are separate from each other. The electrical connection being established between said four stationary contacts upon contact with each of said contacts, said four stationary contacts being electrically connected to said washer pump and said electric source, respectively, said deicer pump being electrically connected to said deicer switch.
